(19) United States
(12) Patent Application Publication
(10) Pub. No.: US 2026/0205406 A1
(43) Pub. Date: Jul. 16, 2026

(54) METHODS, SYSTEMS, AND COMPUTER READABLE MEDIA FOR TESTING ARTIFICIAL INTELLIGENCE (AI) DATA CENTER SWITCHING FABRIC

(71) Applicant: Keysight Technologies, Inc., Santa Rosa, CA (US)

(72) Inventors: Dean Dingtang Lee, Huntington Beach, CA (US); Le Yu, Shanghai (CN)

(21) Appl. No.: 19/554,393

(22) Filed: Mar. 2, 2026

(30) Foreign Application Priority Data
Mar. 10, 2025 (CN) 202510279053.X

(51) Int. Cl. H04L 43/50; H04L 41/14

(52) U.S. Cl. CPC H04L 43/50; H04L 41/145

(57) ABSTRACT

A method for testing an AI data center switching fabric includes configuring a plurality of traffic emulators of a test system to implement a plurality of different categories of performance tests of an AI data center switching fabric. The method further includes generating, by the traffic emulators, emulated AI workload data to implement the different categories of performance tests. The method further includes transmitting, by the traffic emulators, network traffic carrying the emulated AI workload data to the AI data center switching fabric to implement the different categories of performance tests. The method further includes monitoring and outputting, by the traffic emulators, indications of performance of the AI data center switching fabric in each of the different categories of performance tests.

### PRIORITY CLAIM

This application claims the priority benefit of Chinese Patent Application No. 202510279053.X, filed Mar. 10, 2025, the disclosure of which is incorporated herein by reference in its entirety.

### TECHNICAL FIELD

The subject matter described herein relates to testing network devices. More particularly, the subject matter described herein relates to methods, systems, and computer readable media for emulating AI data center graphics processing unit (GPU) workloads and collective communication strategies to validate functionality of an AI data center switching fabrics.

### BACKGROUND

The training of AI large language models (LLMs) requires large numbers or clusters of GPUs interconnected by a switching fabric, which provides low latency and lossless transportation of bursty data chunks. The proper and efficient operation of the AI data center switching fabric is a crucial factor for the efficiency of AI model training. There are innovations and techniques deployed in AI data center switching fabrics to accommodate the bursty nature of LLM traffic patterns and ensure minimum packet loss and retransmission of training data chunks. The validation of the proper operation of an AI data center switching fabric can also require large numbers of GPU clusters, which are difficult to obtain and manage.

Accordingly, in light of these and other difficulties, there exists a need for methods, systems, and computer readable media for testing an AI data center switching fabric.

### SUMMARY

A method for testing an AI data center switching fabric includes configuring a plurality of traffic emulators of a test system to implement a plurality of different categories of performance tests of an AI data center switching fabric. The method further includes generating, by the traffic emulators, emulated AI workload data to implement the different categories of performance tests. The method further includes transmitting, by the traffic emulators, network traffic carrying the emulated AI workload data to the AI data center switching fabric to implement the different categories of performance tests. The method further includes monitoring and outputting, by the traffic emulators, indications of performance of the AI data center switching fabric in each of the different categories of performance tests.

According to another aspect of the subject matter described herein, configuring the traffic emulators to implement the different categories of performance tests includes configuring the traffic emulators to implement at least two of: a job completion time test, a congestion control test, a load balancing test, and a performance isolation test.

According to another aspect of the subject matter described herein, configuring the traffic emulators to implement at least two of: a job completion time test, a congestion control test, a load balancing test, and a performance isolation test includes configuring at least one of the traffic emulators to implement the job completion time test and setting parameters for the job completion time test including a collective communication algorithm, a rank shuffle algorithm, a data size and a remote direct memory access (RDMA) message size to be used in generating the emulated AI workload data.

According to another aspect of the subject matter described herein, generating the emulated AI workload data includes shuffling ranks of emulated network processors to cause the traffic to traverse different portions of the AI data center switching fabric.

According to another aspect of the subject matter described herein, configuring the traffic emulators to implement at least two of: a job completion time test, a congestion control test, a load balancing test, and a performance isolation test includes configuring at least one of the traffic emulators to implement the congestion control test for triggering a congestion control response of the AI data center switching fabric.

According to another aspect of the subject matter described herein, configuring at least one of the traffic emulators to implement the load balancing test includes configuring the at least one traffic emulator to initiate a number of ingress connections to leaf switches in the AI data center switching fabric that exceeds a number of egress connections to the leaf switches in the AI data center switching fabric.

According to another aspect of the subject matter described herein, configuring the traffic emulators to implement at least two of: a job completion time test, a congestion control test, a load balancing test, and a performance isolation test includes configuring at least one of the traffic emulators to implement the load balancing test by varying entropy of the traffic used to carry the emulated AI workload data.

According to another aspect of the subject matter described herein, configuring the traffic emulators to implement at least two of: a job completion time test, a congestion control test, a load balancing test, and a performance isolation test includes configuring the traffic emulators to implement the performance isolation test in which different ones of the traffic emulators emulate different tenants that generate and send the network traffic to different portions of the AI data center switching fabric.

According to another aspect of the subject matter described herein, configuring a plurality of traffic emulators of a test system to implement a plurality of different categories of performance tests of the AI data center switching fabric includes configuring the traffic emulators to emulate a collective communication algorithm among emulated AI workload processors and to shuffle ranks of the emulated AI workload processors.

According to another aspect of the subject matter described herein, transmitting the network traffic carrying the emulated AI workload data to the AI data center switching fabric includes transmitting remote direct memory access (RDMA) write traffic carrying the emulated AI workload data to the AI data center switching fabric.

According to another aspect of the subject matter described herein, a system for testing an artificial intelligence (AI) data center switching fabric is provided. The system includes at least one processor and a memory. The system further includes a plurality of traffic emulators executable by the at least one processor and configured to implement a plurality of different categories of performance tests of an AI data center switching fabric, wherein implementing the different categories of performance tests of the AI data center switching fabric includes generating emulated AI workload data to implement the different categories of performance tests, transmitting network traffic carrying the emulated AI workload data to the AI data center switching fabric to implement the different categories of performance tests, and monitoring and outputting indications of performance of the AI data center switching fabric in each of the different categories of performance tests.

According to another aspect of the subject matter described herein, the traffic emulators are configured to implement at least two of: a job completion time test, a congestion control test, a load balancing test, and a performance isolation test.

According to another aspect of the subject matter described herein, at least one of the traffic emulators is configured to implement the job completion time test and use a collective communication algorithm, a rank shuffle algorithm, a data size and a remote direct memory access (RDMA) message size for carrying the emulated AI workload data in the job completion time test.

According to another aspect of the subject matter described herein, the at least one of the traffic emulators is configured to shuffle ranks of emulated network processors to cause the traffic to traverse different portions of the AI data center switching fabric.

According to another aspect of the subject matter described herein, at least one of the traffic emulators is configured to implement the congestion control test for triggering a congestion control response of the AI data center switching fabric.

According to another aspect of the subject matter described herein, in implementing the congestion control test, the at least one of the traffic emulators is configured to initiate a number of ingress connections to leaf switches in the AI data center switching fabric that exceeds a number of egress connections to the leaf switches in the AI data center switching fabric.

According to another aspect of the subject matter described herein, at least one of the traffic emulators is configured to implement the load balancing test by varying entropy of the traffic used to carry the emulated AI workload data.

According to another aspect of the subject matter described herein, at least one of the traffic emulators is configured to implement the performance isolation test by emulating different tenants that generate and send the network traffic to different portions of the AI data center switching fabric.

According to another aspect of the subject matter described herein, the traffic emulators are configured to emulate a collective communication algorithm among emulated AI workload processors and to shuffle ranks of the emulated AI workload processors.

According to another aspect of the subject matter described herein, a non-transitory computer readable medium having stored thereon executable instructions that when executed by a processor of a computer control the computer to perform steps is provided. The steps include configuring a plurality of traffic emulators of a test system to implement a plurality of different categories of performance tests of an artificial intelligence (AI) data center switching fabric. The steps further include generating, by the traffic emulators, emulated AI workload data to implement the different categories of performance tests. The steps further include transmitting, by the traffic emulators, network traffic carrying the emulated AI workload data to the AI data center switching fabric to implement the different categories of performance tests. The steps further include monitoring and outputting, by the traffic emulators, indications of performance of the AI data center switching fabric in each of the different categories of performance tests.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a block diagram illustrating an exemplary test topology for testing an AI data center switching fabric;

FIG. 2 is a diagram illustrating an example of an AI data center workload that may be emulated by the test system illustrated in FIG. 1;

FIG. 3 illustrates emulated GPUs that may be implemented by the test system and global rank IDs that may be assigned by the test system to the emulated GPUs;

FIG. 4 is a diagram illustrating test objectives and parameters of a job completion time test of a data center switching fabric;

FIG. 5 illustrates the use of a test system to implement rank shuffle for various ring communication patterns;

FIG. 6 illustrates exemplary objectives and parameters of a congestion control test of a data center switching fabric;

FIG. 7 is a diagram illustrating a configuration of a test system for triggering and monitoring data center congestion control mechanisms;

FIG. 8 illustrates exemplary objectives and parameters of a load balancing test of a data center switching fabric;

FIGS. 9 and 10 illustrate exemplary test configurations for performing load balancing tests of a data center switching fabric;

FIG. 11 illustrates exemplary objectives and parameters of a performance isolation test of a data center switching fabric;

FIG. 12 illustrates an exemplary test configuration for a performance isolation test of a data center switching fabric;

FIG. 13 is a block diagram illustrating an exemplary architecture of a test system for testing a data center switching fabric; and

FIG. 14 is a flow chart illustrating an exemplary process for testing a data center switching fabric.

### DETAILED DESCRIPTION

The subject matter described herein includes an AI data center test methodology that uses the traffic emulators and test procedures to mimic the point to point (P2P) data chunk movement within a collective communication between a cluster of GPUs. The test methodology provides a quantifiable and repeatable benchmarking result to compare different implementations and enhancements of an AI data center switching fabric.

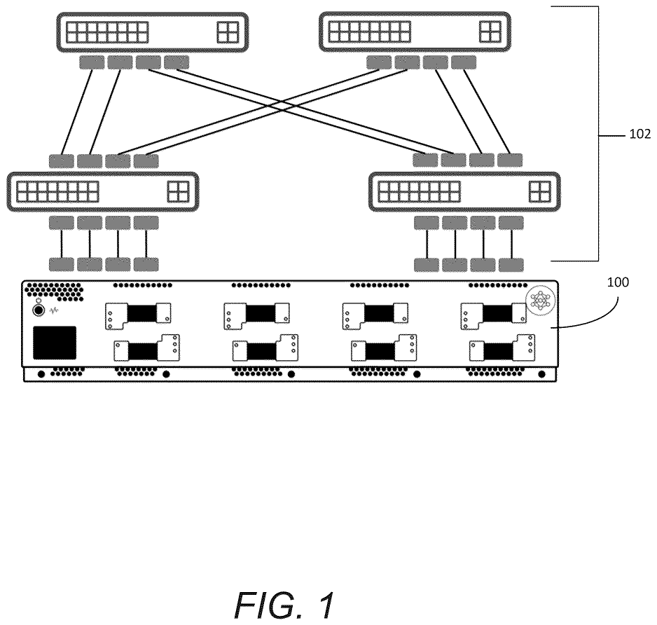

FIG. 1 is a block diagram illustrating an exemplary test topology for testing an AI data center switching fabric. In FIG. 1, the test topology includes test system 100 which includes a plurality of traffic emulators that emulate an AI data center workload and send emulated AI data center traffic carrying data indicative of the emulated AI data center workload into an AI data center switching fabric 102. In the illustrated example, AI data center switching fabric 102 is a multi-tier switching fabric. Test system 100 may emulate an AI workload with collective communications. Exemplary benefits/features of the test topology illustrated in FIG. 1 are:
The ability to achieve high-throughput performance even with massive collective data sizes.
The ability to emulate a multi-tenant AI workload.
The ability to test data center switching fabric congestion control. To simulate realistic network conditions, test system 100 emulates congestion control mechanisms and backpressure effects on a network interface card (NIC), allowing the tester to test and optimize the performance of the data center switching fabric under various traffic scenarios.
The ability to quantify AI model training jobs. To gain a comprehensive understanding of an AI model training process, test system 100 quantifies the completion time of each job and evaluates the AI model training job's bandwidth usage, providing valuable insights into optimization opportunities.
The ability to provide remote direct memory access (RDMA) queue pair (QP) based analysis. To gain deeper insights into the underlying performance of a data center switching fabric, test system 100 conducts an analysis based on RDMA flow metrics, allowing the tester to better comprehend the results and identify potential areas for optimization.
The ability to introduce impairment. To thoroughly assess the robustness of a data center switching fabric, test system 100 may intentionally introduce deliberate failures and stress testing scenarios to emulate real-world conditions, thereby evaluating the resilience of the data center switching fabric and identifying opportunities for improvement.

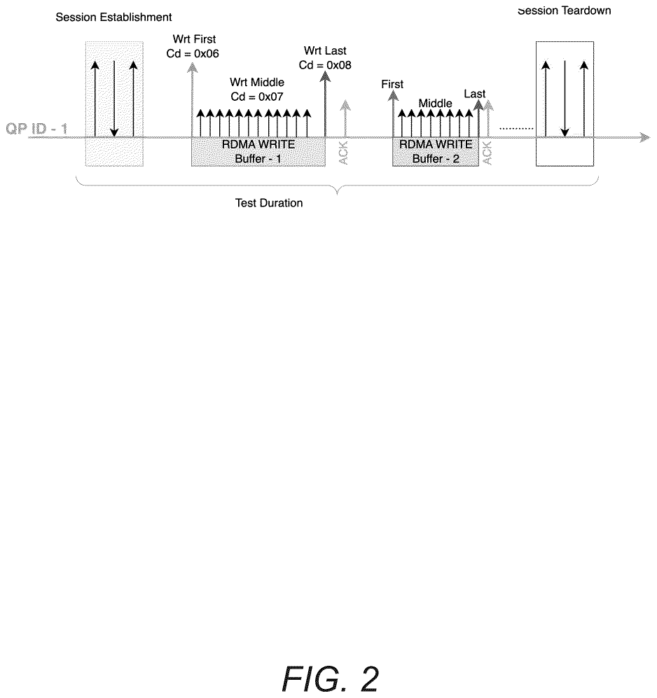

FIG. 2 is a diagram illustrating an example of an AI data center workload that may be emulated by the test system illustrated in FIG. 1. In FIG. 2, test system 100 begins by emulating a session establishment between emulated GPUs. Test system 100 continues the test by sending emulated RDMA write operations through the data center switching fabric. The RDMA write operations may emulate collective communication between GPUs. Collective communication between GPUs is a pattern of distributed P2P connections. Test system 100, in emulating the collective communications, may provide for adjustment of one or more of the following parameters during a test:
NIC capacity and interface speed
Maximum Transmission Unit (MTU) of Ethernet port
RDMA message size
QP per rank
Rank shuffle
   A rank is a number assigned to a collection of GPUs in a cluster to achieve a particular AI/ML processing task. Different parts of an AI data center switching fabric may be programmed to switch traffic associated with different GPU ranks. By shuffling ranks of emulated GPUs, test system 100 can force communications through different parts of AI data center switching fabric 102.

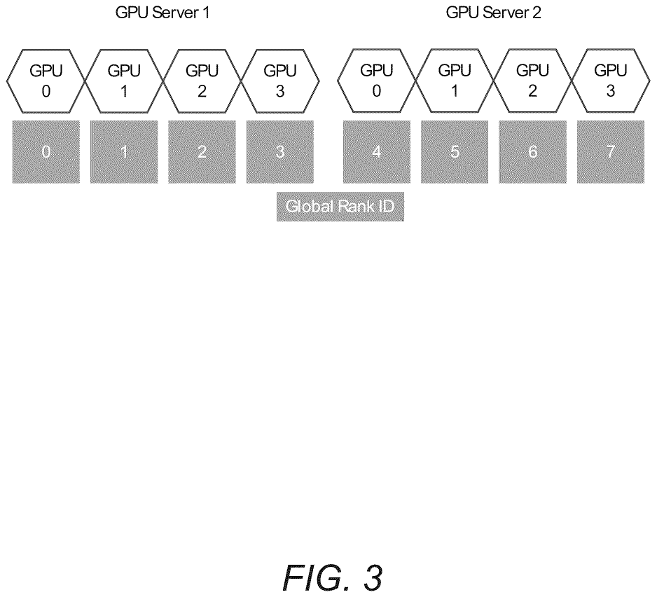

FIG. 3 illustrates emulated GPUs that may be implemented by test system 100 and global rank IDs that may be assigned by test system 100 to the emulated GPUs. Global rank ID is used to identify specific GPU within a cluster for an AI model training job. Since test system 100 emulates each GPU using a traffic emulator, each emulated GPU can be assigned a unique global rank ID. Within a specific test topology, test system 100 can shuffle the global rank IDs to modify the sending sequence of a collective communication. Shuffling the rank IDs refers to changing the rank IDs assigned to emulated GPUs so that the traffic will be switched by different parts of the data center switching fabric.

In testing a data center switching fabric, test system 100 may implement/record the following benchmark and test categories:
Job Completion Time (JCT)
Congestion Control
Load Balancing
Performance Isolation
   Job completion time refers to the time for test system 100 to complete a benchmarking test, such as generating and sending an emulated AI workload through the data center switching fabric. Job completion time is affected by the efficiency and congestion of the AI data center switching fabric. Congestion control in refers to mechanisms by a data center to control congestion. Test system 100 may intentionally trigger data center switching fabric congestion control by transmitting a volume of data into the AI data center switching fabric that exceeds a congestion control threshold, causing the AI data center switching fabric to send congestion control messages, adjusting (or not adjusting) traffic volume in response to the congestion control messages, and monitoring congestion metrics of the data center switching fabric caused by the volume of emulated traffic. Performance isolation refers to isolating specific portions of the AI data center switching fabric to individually test performance of the respective portions, for example, by emulating traffic from different tenants in a multi-tenant data center environment.

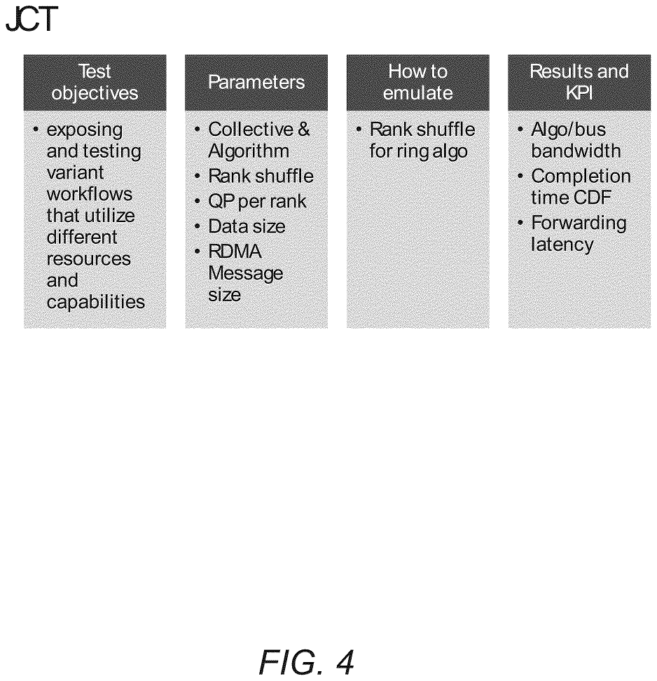

FIG. 4 is a diagram illustrating test objectives and parameters of a test for testing job completion time. To test job completion time, test system 100 emulates AI workflows and transmits traffic associated with the emulated workflows into AI data center switching fabric 102. Exemplary test parameters associated with a particular test may include the collective communication algorithm used, whether or not to implement rank shuffle, number of queue pairs per rank, data size, and RDMA packet size. Once the parameters are selected and the test starts, test system 100 sends the emulated AI workload traffic into the data center switching fabric according to the selected collective communication algorithm, implements rank shuffle, and records bus bandwidth, completion time cumulative distribution function (CDF), and packet forwarding latency.

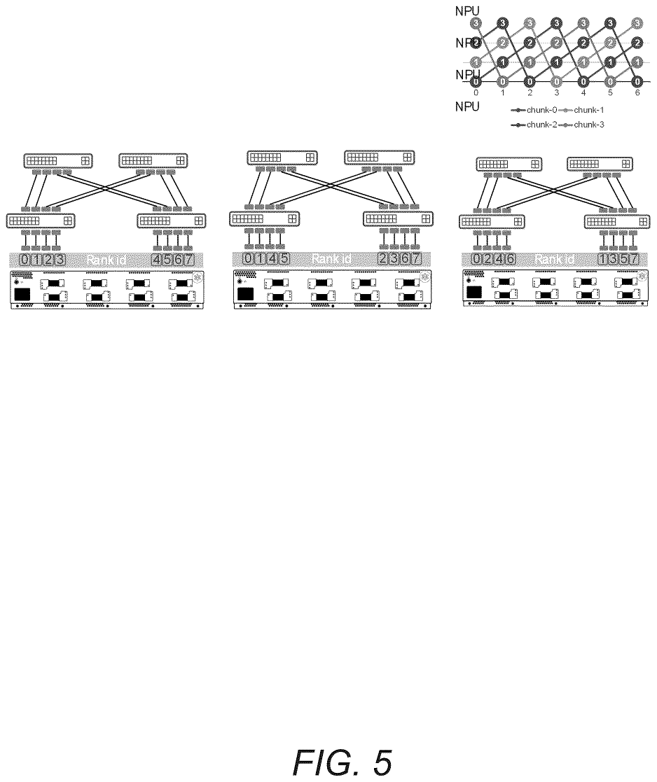

FIG. 5 illustrates the use of test system 100 to implement rank shuffle for various ring communication patterns. In the illustrations at the bottom of FIG. 5, the ranks of emulated network processing units (NPUs) implemented by test system 100 are shuffled from 0, 1, 2, 3, 4, 5, 6, 7 to 0, 1, 4, 5, 2, 3, 6, 7 to 0, 2, 4, 6, 1, 3, 5, 7. The diagram in the upper right corner of FIG. 5 illustrates ring communication patterns of the emulated NPUs. For example, the orange ring pattern of NPUs incudes, in order, NPUs 1, 2, 3, 0, 1, 2, 3. This means that emulated AI/ML workload data travels from NPU 1 to NPU 2, to NPU 3, to NPU 0, to NPU 1, to NPU 2, to NPU 3. To travel between the emulated NPUs, the data traverses the data center switching fabric. Thus, by changing the ranks of the NPUs, the NPUs that form each ring change, and the paths through the data center switching fabric change.

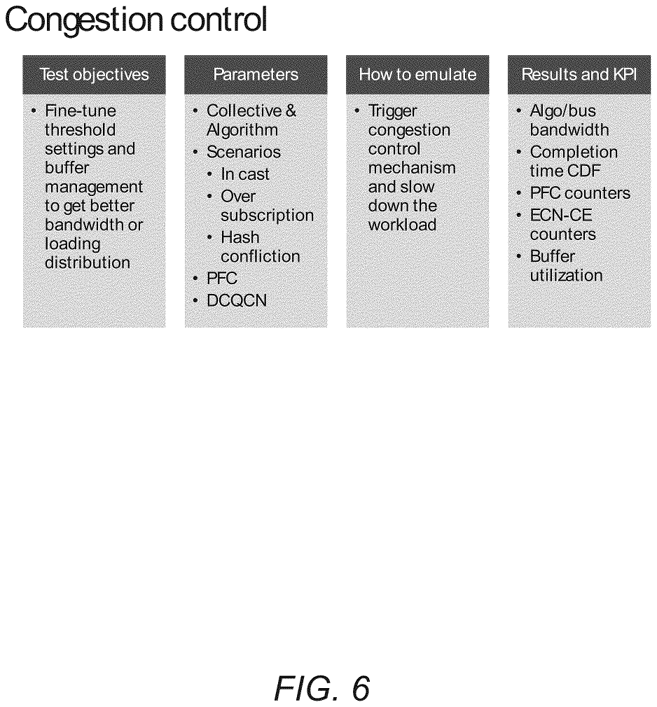

FIG. 6 illustrates exemplary objectives and parameters of a congestion control test of a data center switching fabric. A congestion control test includes transmitting data to a data center switching fabric at a rate configured in intentionally trigger data center congestion control mechanisms, sus as data center quantized congestion notification (DCQCN) and priority flow control (PFC), monitoring the response of the data center switching fabric, slowing down traffic flow in response to the congestion notifications generated by the data center switching fabric, and monitoring bus bandwidth, calculating job completion time, counting PFC messages, counting explicit congestion notification (ECN) messages, etc.

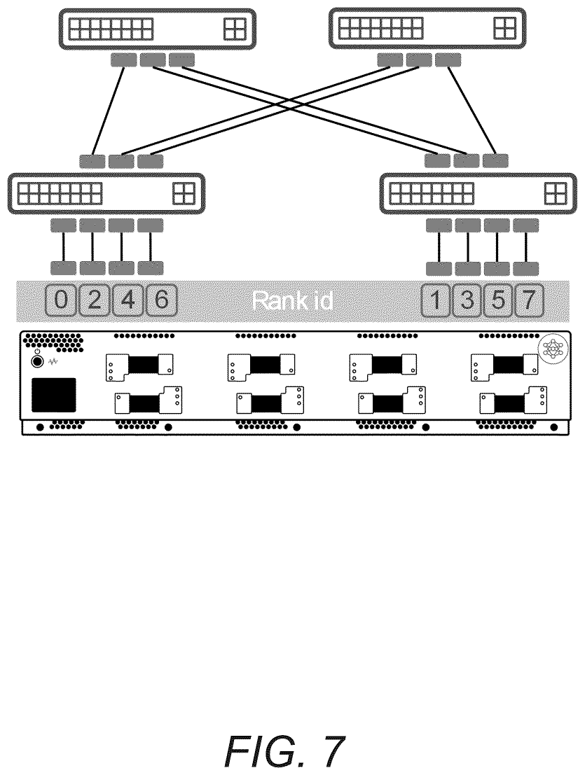

FIG. 7 is a diagram illustrating a configuration of test system 100 for triggering and monitoring data center congestion control mechanisms. In FIG. 7, test system 100 is configured to connect to and send traffic to ingress ports on leaf switches, where the number of ingress ports in the leaf witches is greater than the number of egress ports (4 vs. 3 in the example in FIG. 7). When test system 100 sends emulated data center traffic to the ingress ports of the leaf switches, congestion occurs at the egress ports of the leaf switches. The data center switching fabric responds to the congestion by sending PFC and DCQCN messages to test system 100 to reduce the congestion. Test system 100 monitors the parameters illustrated in FIG. 6 and enables the data center operator to tune queue buffer parameters and congestion mitigation thresholds.

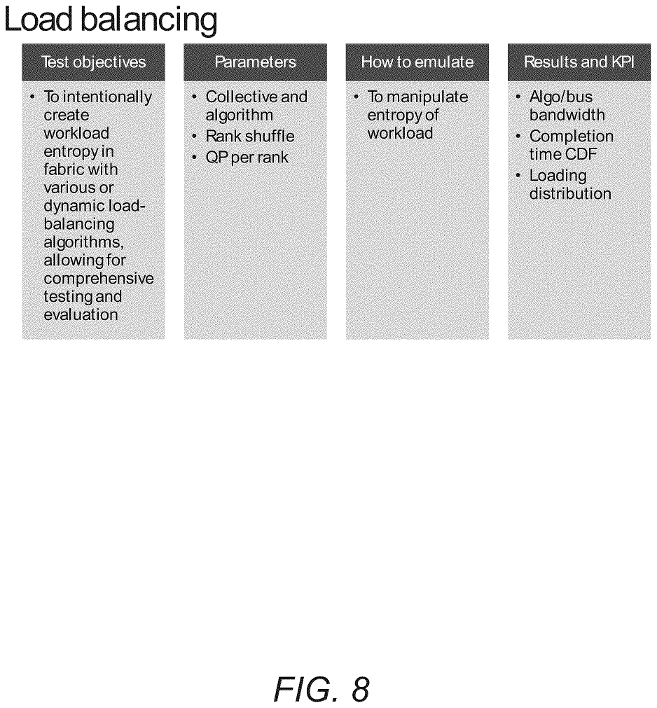

FIG. 8 illustrates exemplary objectives and parameters of a load balancing test of a data center switching fabric. The goal of a load balancing test is to intentionally create workload entropies to cause the load balancing algorithm of the data center switching fabric to send packets to different parts of the data center switching fabric. Creating different workload entropies can include varying the collective communication algorithm, performing rank shuffling, and changing the number of queue pairs per rank. Results measured by test system 100 in a load balancing test may include bus bandwidth in the data center switching fabric, job completion time, and loading distribution of the data center switching fabric.

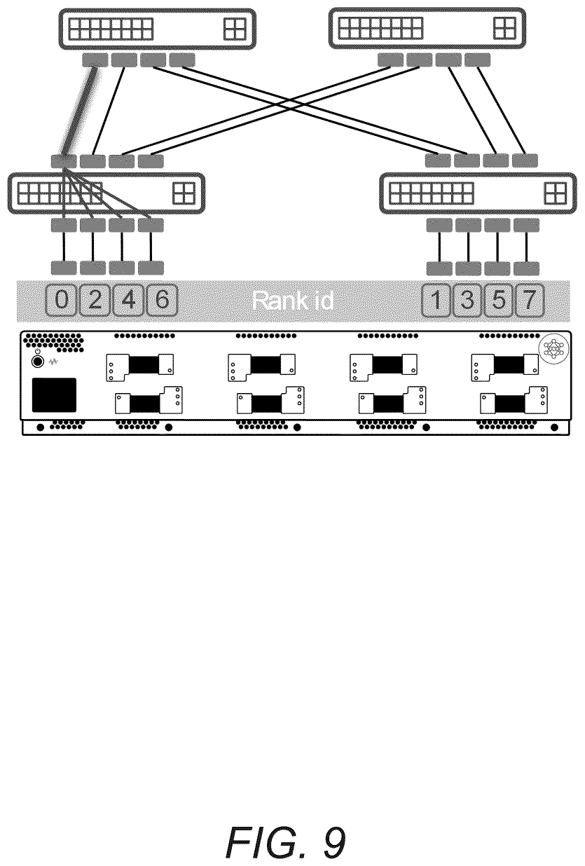

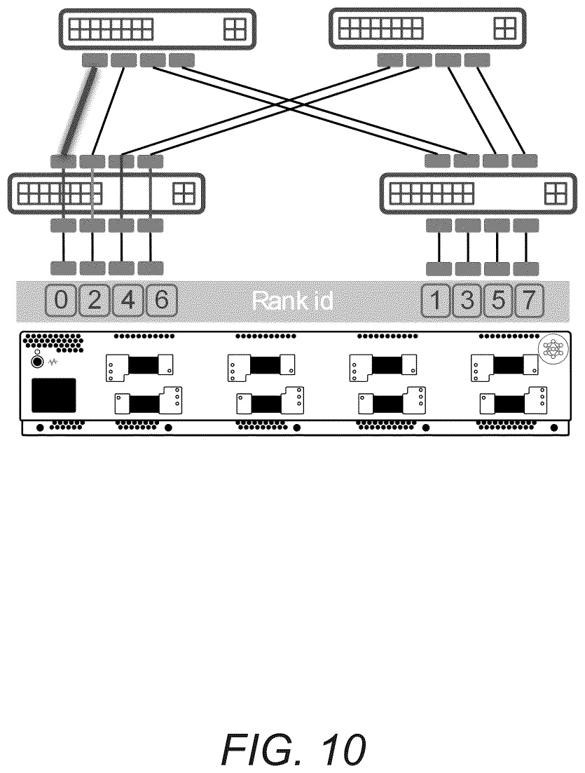

FIGS. 9 and 10 illustrate exemplary test configurations for performing load balancing tests of a data center switching fabric. In FIG. 9, test system 100 is configured to send equal cost muti-path (ECMP)-routed packets into the data center switching fabric. The collective communication algorithm in FIG. 9 is a ring algorithm with a single queue pair per rank and the packet size of the ECMP-routed packets is small. In FIG. 10, test system 100 is configured to use an all to all collective communication algorithm with parallel queue pairs per rank and a larger packet size than the ECMP-routed packets used in FIG. 10. The load balancing algorithm used by the data center switching fabric and FIG. 10 is an ingress port hash of 6 tuples in the ingress packets.

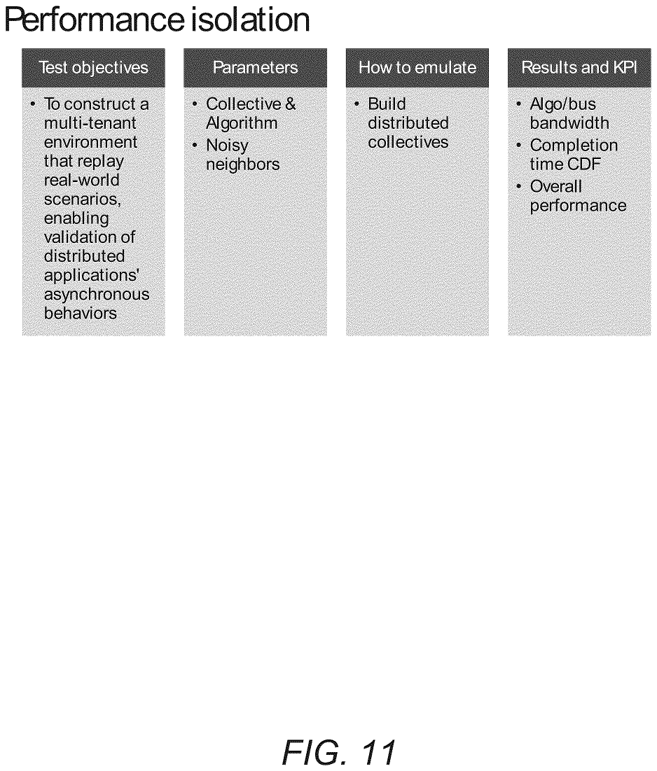

FIG. 11 illustrates exemplary objectives and parameters of a performance isolation test of a data center switching fabric. In FIG. 11, the test objectives of a performance isolation test include constructing a multi-tenant environment to replay real world scenarios where different tenants use different parts of the data center switching fabric. Parameters for each test include the collective communication algorithm and noisy neighbors. Implementing a noisy neighbors test scenario may include transmitting a high volume of emulated AI workload traffic from one emulated tenant into the AI data center switching fabric and monitoring the effect of the high volume of traffic on data center resources used by a different emulated tenant of the data center. Performance measurements captured by test system 100 in a performance isolation test may include data center bus bandwidth, job completion time, and other overall performance measurements.

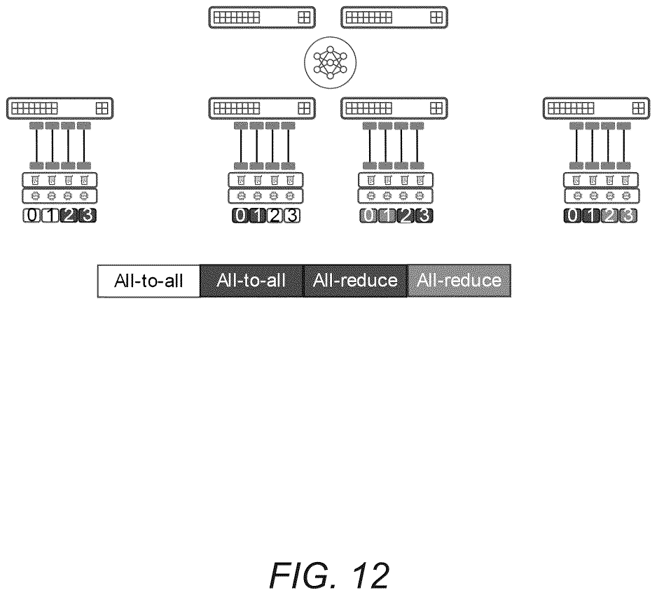

FIG. 12 illustrates an exemplary test configuration for performing a performance isolation test of a data center switching fabric. In FIG. 12, individual traffic emulators of test system 100 are connected to different parts of the data center switching fabric, and those parts are logically isolated from each other as they serve different clients or tenants. Test system 100 may exercise each individual portion of the data center switching fabric by generating emulated traffic for each emulated data center client and transmitting the emulated data center traffic into the data center switching fabric. Each emulated client workload may be configured with packet size, collective communication algorithm, traffic load, etc., to determine how the data center switching fabric performs with traffic from different clients or tenants.

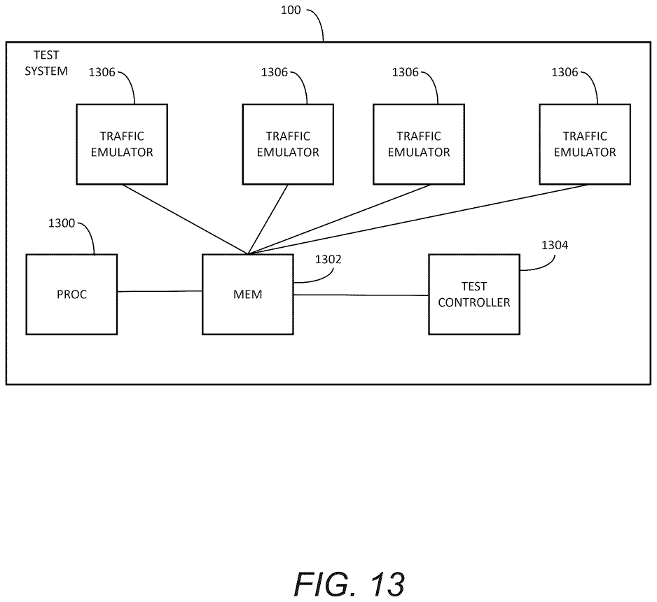

FIG. 13 is a block diagram illustrating an exemplary architecture of a test system for testing a data center switching fabric. Referring to FIG. 13, test system 100 includes at least one processor 1300 and memory 1302. Test system 100 further includes a test controller 1304 for controlling the overall operation of test system 100 and for configuring test system 100 to perform the individual tests described herein. Test system 100 also includes a plurality of traffic emulators 1306 that generate the emulated AI workloads, transmit the packetized traffic that carries the emulated AI workloads to the data center switching fabric, and monitors the performance of the data center switching fabric. Traffic emulators 1306 and test controller 1304 may be implemented using computer executable instructions stored in memory 1302 and executed by processor 1300.

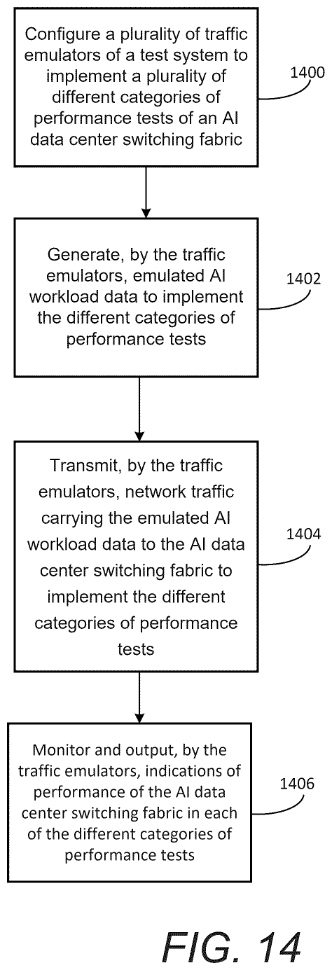

FIG. 14 is a flow chart illustrating an exemplary process for testing a data center switching fabric. Referring to FIG. 14, in step 1400, the process includes configuring a plurality of traffic emulators of a test system to implement a plurality of different categories of performance tests of an AI data center switching fabric. For example, a test system, such as test system 100 may be configured to perform two or more of a job completion time test, a congestion control test, a load balancing test, and a performance isolation test of an AI data center switching fabric.

In step 1402, the process further includes generating, by the traffic emulators, emulated AI workload data to implement the different categories of performance tests. For example, traffic emulators 1306 of test system 100 may emulate AI workload processors, including a collective communication algorithm and a rank shuffle algorithm and generate data that emulates a real AI workload, such as a workload for training a large language model.

In step 1404, the process further includes transmitting, by the traffic emulators, network traffic carrying the emulated AI workload data to the AI data center switching fabric to implement the different categories of performance tests. For example, traffic emulators 1306 may generate RDMA messages that carry the emulated AI workload data.

In step 1406, the process includes monitoring and outputting, by the traffic emulators, indications of performance of the AI data center switching fabric in each of the different categories of performance tests. For example, traffic emulators 1306 may monitor and output indications of job completion time, data center bus bandwidth, data center switch buffer utilization, counts of congestion control messages generated by the AI data center switching fabric, etc.

The foregoing description is for the purpose of illustration only, and not for the purpose of limitation, as the subject matter described herein is defined by the claims as set forth hereinafter.

What is claimed is:

1. A method for testing an artificial intelligence (AI) data center switching fabric, the method comprising:
configuring a plurality of traffic emulators of a test system to implement a plurality of different categories of performance tests of an AI data center switching fabric;
generating, by the traffic emulators, emulated AI workload data to implement the different categories of performance tests;
transmitting, by the traffic emulators, network traffic carrying the emulated AI workload data to the AI data center switching fabric to implement the different categories of performance tests; and
monitoring and outputting, by the traffic emulators, indications performance of the AI data center switching fabric in each of the different categories of performance tests.

2. The method of claim 1 wherein the configuring the traffic emulators to implement the different categories of performance tests includes configuring the traffic emulators to implement at least two of: a job completion time test, a congestion control test, a load balancing test, and a performance isolation test.

3. The method of claim 2 wherein configuring the traffic emulators to implement at least two of: a job completion time test, a congestion control test, a load balancing test, and a performance isolation test includes configuring at least one of the traffic emulators to implement the job completion time test and setting parameters for the job completion time test including a collective communication algorithm, a rank shuffle algorithm, a data size and a remote direct memory access (RDMA) message size to be used in generating the emulated AI workload data.

4. The method of claim 3 wherein generating the emulated AI workload data includes shuffling ranks of emulated network processors to cause the traffic to traverse different portions of the AI data center switching fabric.

5. The method of claim 2 wherein configuring the traffic emulators to implement at least two of: a job completion time test, a congestion control test, a load balancing test, and a performance isolation test includes configuring at least one of the traffic emulators to implement the congestion control test for triggering a congestion control response of the AI data center switching fabric.

6. The method of claim 5 wherein configuring at least one of the traffic emulators to implement the load balancing test includes configuring the at least one traffic emulator to initiate a number of ingress connections to leaf switches in the AI data center switching fabric that exceeds a number of egress connections to the leaf switches in the AI data center switching fabric.

7. The method of claim 2 wherein configuring the traffic emulators to implement at least two of: a job completion time test, a congestion control test, a load balancing test, and a performance isolation test includes configuring at least one of the traffic emulators to implement the load balancing test by varying entropy of the traffic used to carry the emulated AI workload data.

8. The method of claim 2 wherein configuring the traffic emulators to implement at least two of: a job completion time test, a congestion control test, a load balancing test, and a performance isolation test includes configuring the traffic emulators to implement the performance isolation test in which different ones of the traffic emulators emulate different tenants that generate and send the network traffic to different portions of the AI data center switching fabric.

9. The method of claim 1 wherein configuring a plurality of traffic emulators of a test system to implement a plurality of different categories of performance tests of the AI data center switching fabric includes configuring the traffic emulators to emulate a collective communication algorithm among emulated AI workload processors and to shuffle ranks of the emulated AI workload processors.

10. The method of claim 1 wherein transmitting the network traffic carrying the emulated AI workload data to the AI data center switching fabric includes transmitting remote direct memory access (RDMA) write traffic carrying the emulated AI workload data to the AI data center switching fabric.

11. A system for testing an artificial intelligence (AI) data center switching fabric, the system comprising:
at least one processor and a memory; and
a plurality of traffic emulators executable by the at least one processor and configured to implement a plurality of different categories of performance tests of an AI data center switching fabric, wherein implementing the different categories of performance tests of the AI data center switching fabric includes:
generating emulated AI workload data to implement the different categories of performance tests;
transmitting network traffic carrying the emulated AI workload data to the AI data center switching fabric to implement the different categories of performance tests; and
monitoring and outputting indications of performance of the AI data center switching fabric in each of the different categories of performance tests.

12. The system of claim 11 wherein the traffic emulators are configured to implement at least two of: a job completion time test, a congestion control test, a load balancing test, and a performance isolation test.

13. The system of claim 12 wherein at least one of the traffic emulators is configured to implement the job completion time test and use a collective communication algorithm, a rank shuffle algorithm, a data size and a remote direct memory access (RDMA) message size for carrying the emulated AI workload data in the job completion time test.

14. The system of claim 13 wherein the at least one of the traffic emulators is configured to shuffle ranks of emulated network processors to cause the traffic to traverse different portions of the AI data center switching fabric.

15. The system of claim 12 wherein at least one of the traffic emulators is configured to implement the congestion control test for triggering a congestion control response of the AI data center switching fabric.

16. The system of claim 15 wherein, in implementing the congestion control test, the at least one of the traffic emulators is configured to initiate a number of ingress connections to leaf switches in the AI data center switching fabric that exceeds a number of egress connections to the leaf switches in the AI data center switching fabric.

17. The system of claim 12 wherein at least one of the traffic emulators is configured to implement the load balancing test by varying entropy of the traffic used to carry the emulated AI workload data.

18. The system of claim 12 wherein at least one of the traffic emulators is configured to implement the performance isolation test by emulating different tenants that generate and send the network traffic to different portions of the AI data center switching fabric.

19. The system of claim 11 wherein the traffic emulators are configured to emulate a collective communication algorithm among emulated AI workload processors and to shuffle ranks of the emulated AI workload processors.

20. A non-transitory computer readable medium having stored thereon executable instructions that when executed by a processor of a computer control the computer to perform steps comprising:
configuring a plurality of traffic emulators of a test system to implement a plurality of different categories of performance tests of an artificial intelligence (AI) data center switching fabric;
generating, by the traffic emulators, emulated AI workload data to implement the different categories of performance tests;
transmitting, by the traffic emulators, network traffic carrying the emulated AI workload data to the AI data center switching fabric to implement the different categories of performance tests; and
monitoring and outputting, by the traffic emulators, indications of performance of the AI data center switching fabric in each of the different categories of performance tests.
